(19) United States
(12) Patent Application Publication
(10) Pub. No.: US 2026/0356207 A1
(43) Pub. Date: Nov. 12, 2026

(54) ELECTRIFIED VEHICLE AND CONTROL METHOD THEREOF

(71) Applicants: Hyundai Motor Company, Seoul (KR); Kia Corporation, Seoul (KR)

(72) Inventors: Chae Duck CHON, Hwaseong-si (KR); Deuk Hoon KOH, Hwaseong-si (KR)

(73) Assignees: Hyundai Motor Company, Seoul (KR); Kia Corporation, Seoul (KR)

(21) Appl. No.: 19/405,842

(22) Filed: Dec. 2, 2025

(30) Foreign Application Priority Data
May 12, 2025 (KR) 10-2025-0061433

(51) Int. Cl. B60L 15/20; H02P 21/22; H02P 27/08

(52) U.S. Cl. CPC B60L 15/20; H02P 21/22; H02P 27/08; B60L 2210/40; B60L 2240/423; B60L 2240/425; B60L 2250/28

(57) ABSTRACT

In an electrified vehicle and its control method, the electrified vehicle includes a motor, an inverter connected to the motor and configured to drive the motor, and a controller operatively connected to the inverter and controlling the inverter based on a torque command. The controller is further configured to selectively apply a second torque value corresponding to a current target torque to the torque command based on a first torque value determined based on sensing information of the motor and the inverter.

### CROSS-REFERENCE TO RELATED APPLICATION

The present application claims priority from Korean Patent Application No. 10-2025-0061433 filed on May 12, 2025 in the Korean Intellectual Property Office, the present disclosure of which is incorporated herein by reference in its entirety.

### BACKGROUND OF THE PRESENT DISCLOSURE

### Field of the Present Disclosure

The present disclosure relates to an electrified vehicle driven via a motor and an inverter and its control method.

### Description of Related Art

An electrified vehicle includes an electric motor as its power source. The electric motor generates rotational force using power supplied from a battery and transfers the present rotational force to the driveshaft of the vehicle to move the vehicle. Such electrified vehicles are also referred to as eco-friendly vehicles, and examples include Electric Vehicles (EV), Hybrid Electric Vehicles (HEV), and Plug-in Hybrid Vehicles (PHEV).

An inverter is generally used for driving and controlling the motor, which is the power source of the electrified vehicle. The inverter serves to drive the motor by converting DC power supplied from the battery to AC and performs the function of adjusting voltage and frequency to control the motor speed and output power.

Torque control is a crucial factor that determines the performance of the vehicle and the driving experience of the driver in electrified vehicles. The accuracy and precision of torque control directly affects the acceleration performance, energy consumption rate, and ride comfort of the electrified vehicle. Therefore, there is a need for a control method that can improve the accuracy of torque control.

The above matters disclosed in the present section are merely for enhancement of understanding of the general background of the present disclosure and should not be taken as an acknowledgement or any form of suggestion that the matters form the related art already known to a person skilled in the art.

### BRIEF SUMMARY

Therefore, the present disclosure has been made in view of the above problems, and it is an object of the present disclosure to provide an electrified vehicle and its control method with improved torque control accuracy through a motor and an inverter.

The objects of the present disclosure are not limited to those mentioned above, and other objects not mentioned can be clearly understood by those skilled in the art from the following description.

According to various aspects of the present disclosure, there is provided an electrified vehicle including a motor, an inverter connected to the motor and configured to drive the motor, and a controller operatively connected to the inverter and controlling the inverter based on a torque command. The controller is further configured to selectively apply a second torque value corresponding to a current target torque to the torque command based on a first torque value determined based on sensing information of the motor and the inverter.

According to various aspects of the present disclosure, there is provided a control method of an electrified vehicle including a motor and an inverter connected to the motor and configured to drive the motor. The method includes selectively applying a second torque value corresponding to a current target torque to a torque command based on a first torque value determined based on sensing information of the motor and the inverter, and controlling the inverter based on the torque command.

According to various aspects of the present disclosure as described above, the accuracy of torque control through the motor and inverter can be improved.

Additionally, since the normality of the torque command can be diagnosed at the motor controller level itself without using an upper-level controller, the diagnosis of the torque command and the response according to the diagnosis result can be performed promptly.

The effects obtainable from the present disclosure are not limited to those described above, and other effects not mentioned will be clearly understood by those skilled in the art from the following description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating the configuration of an electrified vehicle according to an exemplary embodiment of the present disclosure;

FIG. 2 is a diagram explaining the torque inverse-calculation process of a controller according to an exemplary embodiment of the present disclosure;

FIG. 3 is a diagram explaining the torque command determination process of a controller according to an exemplary embodiment of the present disclosure; and

FIG. 4 is a flowchart explaining the control method of an electrified vehicle according to an exemplary embodiment of the present disclosure.

### DETAILED DESCRIPTION

Hereinafter, various exemplary embodiments of the present disclosure will be described in detail with reference to the accompanying drawings. The specific structural and functional descriptions of embodiments of the present disclosure disposed herein are merely for the purpose of explaining exemplary embodiments of the present disclosure. Embodiments of the present disclosure can be implemented in various forms and should not be construed as being limited to the embodiments described herein.

Hereinafter, specific embodiments of the present disclosure will be illustrated and described in detail with reference to the accompanying drawings. However, this is not intended to limit the present disclosure to specific disclosed forms, and it should be understood that the present disclosure includes all changes, equivalents, and substitutions within the spirit and technical scope of the present disclosure.

Unless otherwise defined, all technical and scientific terms used herein, including those related to engineering or science, have the same meaning as commonly understood by those skilled in the art to which the present disclosure belongs. Generally used terms as defined in common dictionaries should be interpreted as having meanings consistent with the context of the relevant art and should not be interpreted in an idealized or overly formal sense unless expressly defined herein.

In the following description of the embodiments of the present disclosure with reference to the appended drawings, the same or similar components are designated by the same reference numerals regardless of the figure numbers, and redundant description thereof will be omitted.

In the description of the following embodiments, the term "predetermined" means that the numerical value of a parameter is determined in advance when used in a process or algorithm. Depending on the exemplary embodiment of the present disclosure, the parameter value may be set at the start of the process or algorithm or may be set during the execution of the process or algorithm.

In the following description, the suffixes "module" and "unit" used for components are provided or used interchangeably only for the ease of preparing the specification, and they do not have distinct meanings or functions.

In describing embodiments of the present disclosure, detailed descriptions of related known technologies may be omitted if they are deemed to obscure the gist of the present disclosure. Also, the appended drawings are provided to facilitate understanding of the exemplary embodiments of the present disclosure and the technical idea of the present disclosure should not be limited by the appended drawings. It should be understood that the present disclosure includes all changes, equivalents, and substitutions within the spirit and technical scope of the present disclosure.

Terms including ordinals such as "first," "second," etc. may be used to describe various components, but these components should not be limited by these terms. These terms are used only to distinguish one component from another component. For example, a first component may be referred to as a second component without departing from the scope of the present disclosure, and similarly, the second component may also be referred to as the first component.

When a component is referred to as being "connected" or "coupled" to another component, it should be understood that the component may be directly connected or coupled to the other component, but there may be another component in between. On the other hand, when a component is referred to as being "directly connected" or "directly coupled" to another component, it should be understood that there is no other component in between.

Singular expressions include plural expressions unless the context clearly indicates otherwise.

In the present disclosure, terms such as "include" or "have" are intended to indicate the existence of features, numbers, steps, operations, components, parts, or combinations thereof disclosed in the specification, and should not be construed as excluding the presence or addition of one or more other features, numbers, steps, operations, components, parts, or combinations thereof.

Also, the terms "unit" or "control unit" included in the names such as motor control unit (MCU), hybrid control unit (HCU), etc., are merely terms widely used in naming controllers that control specific functions of a vehicle and do not mean generic function units.

According to an exemplary embodiment of the present disclosure, the electrified vehicle is configured to control the inverter based on a torque command to drive the motor, but is configured to determine whether to apply a second torque value corresponding to the current target torque to the torque command based on a first torque value determined based on sensing information, thereby improving the accuracy and reliability of torque control.

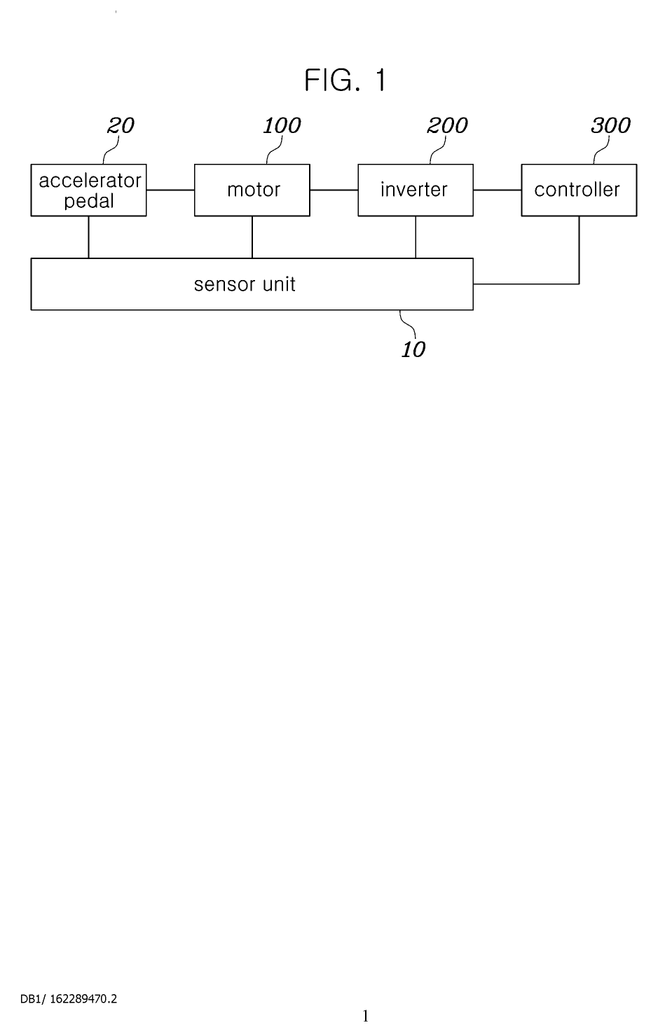

Hereinafter, the configuration of the electrified vehicle according to an exemplary embodiment of the present disclosure will be first explained with reference to FIG. 1.

FIG. 1 is a diagram illustrating the configuration of an electrified vehicle according to an exemplary embodiment of the present disclosure.

Referring to FIG. 1, the electrified vehicle according to an exemplary embodiment of the present disclosure includes a motor 100, an inverter 200, a controller 300, and may further include a sensor unit 10 and an accelerator pedal 20. However, FIG. 1 mainly illustrates components related to the description of an exemplary embodiment of the present disclosure, so that the actual electrified vehicle may be implemented with more components.

First, the motor 100 is configured as the power source of the electrified vehicle, receives AC power, and provides driving force to the driving wheel of the electrified vehicle. For example, the motor 100 may include a plurality of windings.

The inverter 200 is a power conversion device for controlling the motor 100. The inverter 200 can drive the motor 100 by converting DC power to AC power and providing it to the motor 100, and in the process, can adjust the torque output from the motor 100. For example, the inverter 200 may include a plurality of legs each connected to the plurality of windings of the motor 100, and the plurality of legs may be disposed with a plurality of switching elements that are complementarily switched.

The controller 300 selectively applies a second torque value corresponding to the current target torque to the torque command based on the first torque value, and is configured to control the inverter based on the torque command with the second torque value selectively applied. For this, the controller 300 may include a communication device for communicating with other controllers or sensors, a memory for storing operating systems or logic instructions and input/output information, and one or more processors for performing judgments, calculations, and decisions necessary for controlling the assigned function. For example, the controller 300 may be implemented as a motor control unit (MCU) disposed in the electrified vehicle to control the motor 100 and the inverter 200.

For example, the controller 300 can generate a current command to satisfy the torque command, and can generate a voltage command through feedback control for the current command. The controller 300 can generate a pulse width modulation (PWM) signal based on the voltage command thus generated, and control the driving of the motor by controlling the switching of the inverter 200 through the generated PWM signal. For example, the PWM signal may include the switching duty for each switching element included in the inverter 200, and the inverter 200 may drive the motor 100 by turning ON/OFF each switching element according to the switching duty.

The sensor unit 10 may, for example, detect sensing information about the motor 100 and the inverter 200, such as the PWM signal applied to the inverter 200, the rotor position of the motor 100, the phase current flowing through the windings of the motor 100, the DC voltage applied to the inverter 200, the temperature of the motor 100, etc., and may further detect the position of the accelerator pedal 20.

For example, the sensor unit 10 may include a signal sensor connected to a gate driver of the inverter 200, through which it can detect the PWM signal.

For example, the sensor unit 10 may include a Hall sensor, an encoder, a resolver, etc., through which it can detect the rotor position of the motor 100. However, the detection method is not necessarily limited to this, and the sensor unit 10 may also indirectly detect the rotor position based on measured back electromotive force.

For example, the sensor unit 10 may include a current sensor connected to the windings of the motor 100, and detect the phase current through the current sensor.

For example, the sensor unit 10 may include a voltage sensor connected to the DC link of the inverter 200, and detect the DC voltage through the voltage sensor.

For example, the sensor unit 10 may include a temperature sensor connected to the windings of the motor 100, through which it can detect the temperature of the motor 100. However, the detection method is not necessarily limited to this, and the sensor unit 10 may indirectly detect the temperature of the motor 100 through the temperature of the coolant that cools the motor 100.

For example, the sensor unit 10 may include an accelerator position sensor (APS), through which it can detect the position of the accelerator pedal.

The sensor unit 10 can transmit the detected sensing information to the controller 300, and the controller 300 can check the status of the motor 100 and the inverter 200 using the sensing information.

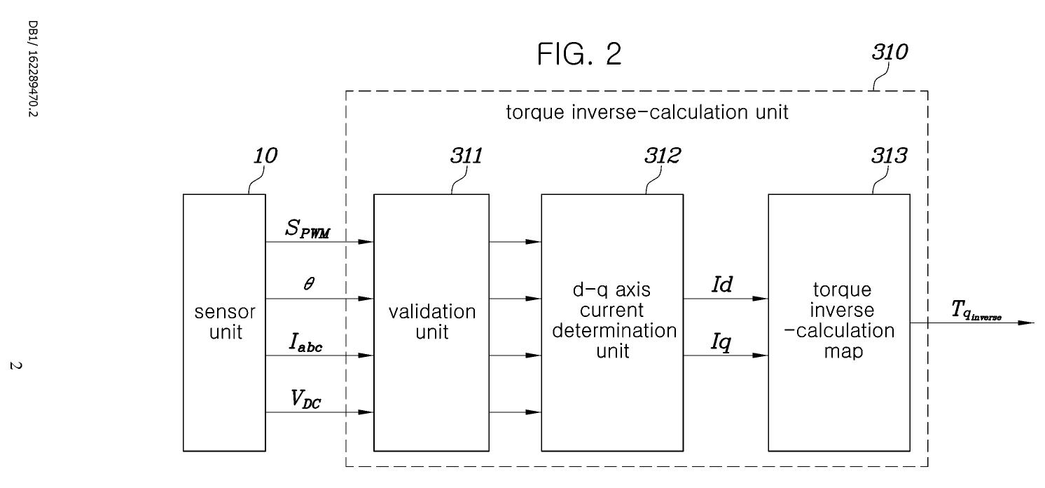

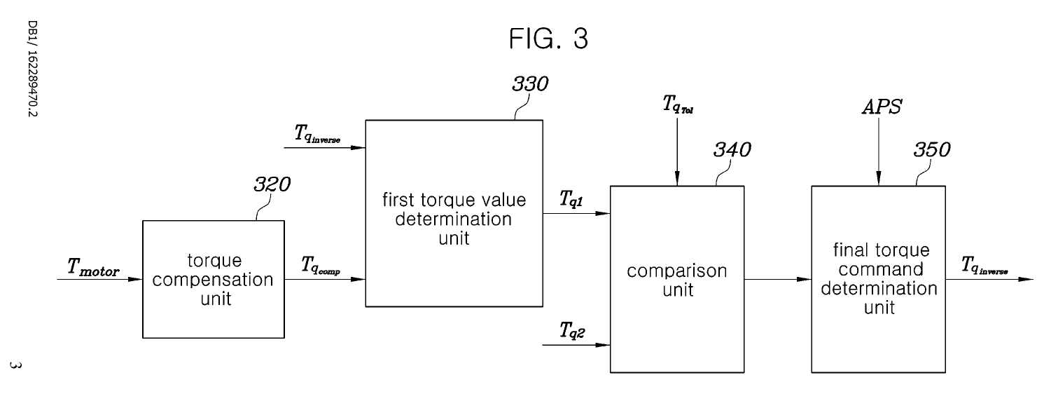

Meanwhile, more detailed content regarding the driving control of the motor performed in the controller 300 will be described below with reference to FIGS. 2 and 3.

First, FIG. 2 is a diagram explaining the torque inverse-calculation process of a controller according to an exemplary embodiment of the present disclosure.

Referring to FIG. 2, the controller according to various exemplary embodiments of the present disclosure may include a torque inverse-calculation unit 310.

The torque inverse-calculation unit 310 includes a validation unit 311, a d-q axis current determination unit 312, and a torque inverse-calculation map 313, and can output an inverse-calculated torque value (Tq_inverse) based on the sensing information obtained from the sensor unit 10.

The torque inverse-calculation unit 310 can obtain the PWM signal (S_PWM), rotor position (θ), phase current (I_abc), and DC voltage (V_DC) as sensing information from the sensor unit 10.

The validation unit 311 can perform validation on the sensing information, including checking whether the sensing information is within a predetermined normal range. For example, the validation unit 311 can pass only values that exist within the normal range and filter out values that are outside the normal range.

The d-q axis current determination unit 312 can determine the d-q axis current (Id, Iq) based on the sensing information. Here, the d-q axis current (Id, Iq) refers to the d-axis current (Id) and q-axis current (Iq) in the d-q axis synchronous reference frame, which can be understood as values representing the phase current of the motor 100 through the d-q axis synchronous reference frame. For example, the d-q axis current determination unit 312 may include a pre-mapped current map with d-q axis current (Id, Iq) values corresponding to the sensing information, and may be implemented to output the corresponding d-q axis current (Id, Iq) according to the input sensing information.

The torque inverse-calculation map 313 can output an inverse-calculated torque value (Tq_inverse) corresponding to the d-q axis current (Id, Iq). For example, it may be preset to have the d-q axis current (Id, Iq) as input values and the corresponding inverse-calculated torque value (Tq_inverse) as output values. The present torque inverse-calculation map 313 can be set using a current map for converting the torque command to a current command, and may be implemented in a form that applies the input and output values of the current map in reverse.

The inverse-calculated torque value (Tq_inverse) output through the torque inverse-calculation unit 310 as described above can be used to determine the first torque value, which will be explained below with reference to FIG. 3.

FIG. 3 is a diagram explaining the torque command determination process of a controller according to an exemplary embodiment of the present disclosure.

Referring to FIG. 3, the controller 300 may include, in addition to the torque inverse-calculation unit 310, a torque compensation unit 320, a first torque value determination unit 330, a comparison unit 340, and a final torque command determination unit 350.

First, the torque compensation unit 320 can determine a compensation torque value (Tq_comp) based on the temperature of the motor 100 (T_motor) included in the sensing information. For example, the compensation torque value (Tq_comp) may be preset for each temperature of the motor 100 (T_motor).

The first torque value determination unit 330 can determine the first torque value (Tq1) based on the inverse-calculated torque value (Tq_inverse) and the compensation torque value (Tq_comp). For example, the first torque value determination unit 330 may be configured to determine the first torque value (Tq1) as the value obtained by subtracting the compensation torque value (Tq_comp) from the inverse-calculated torque value (Tq_inverse).

The comparison unit 340 can receive the determined first torque value (Tq1), a second torque value (Tq2) corresponding to the torque command applied to the inverter 200, and a predetermined reference value (Tq_tol). Here, since the first torque value (Tq1) is determined based on the sensing information of the motor 100 and the inverter 200, it can be understood as a value representing the actual torque or the torque command applied immediately before, according to the current operating state of the motor 100 and the inverter 200. The second torque value (Tq2) corresponds to the target torque for torque control of the motor 100. For example, it may be a value input to the current map for current control of the inverter 200, and the target torque may be provided by or based on an upper-level controller.

The comparison unit 340 can compare the difference between the first torque value (Tq1) and the second torque value (Tq2) with the predetermined reference value (Tq_tol), and output the comparison result, which can be input to the final torque command determination unit 350.

The final torque command determination unit 350 is configured to determine whether the second torque value (Tq2) satisfies a predetermined condition and is configured to determine the final torque command (Tq_final) according to whether the predetermined condition is satisfied. Here, the predetermined condition is set with respect to the first torque value (Tq1), and whether the second torque value (Tq2) satisfies the predetermined condition can be determined according to the first torque value (Tq1).

For example, the predetermined condition may be satisfied when the second torque value (Tq2) has the same sign as the first torque value (Tq1), or when the second torque value (Tq2) has a difference from the first torque value (Tq1) less than or equal to the reference value (Tq_tol). Also, the predetermined condition may be satisfied when the first torque value (Tq1) and the second torque value (Tq2) have the same sign, and the difference between the first torque value (Tq1) and the second torque value (Tq2) is less than or equal to the reference value (Tq_tol).

The final torque command determination unit 350 can apply the second torque value (Tq2) to the torque command if the predetermined condition is satisfied, and if the predetermined condition is not satisfied, it may not apply the second torque value (Tq2) to the torque command. When the final torque command determination unit 350 does not apply the second torque value (Tq2) to the torque command, it may determine a predetermined third torque value (for example, 0 Nm) as the torque command (Tq_final).

That is, the final torque command determination unit 350 can verify the second torque value (Tq2) based on the first torque value (Tq1) based on the sensing information of the motor 100 and the inverter 200, and evaluate the reliability and accuracy of the second torque value (Tq2) through the predetermined condition to determine the torque command (Tq_final) to be finally applied to the control of the inverter 200.

According to the present method, unlike the method of evaluating the reliability and accuracy of the target torque through the torque command from an upper-level controller such as a vehicle control unit (VCU) or a hybrid control unit (HCU), the torque command can be determined by evaluating the reliability and accuracy of the target torque independently without cooperative control with the upper-level controller. Therefore, it is possible to prevent delays due to communication between controllers, and the verification of the target torque and the determination of the torque command (Tq_final) according to the result can be performed rapidly.

Subsequently, the controller 300 is configured to control the inverter 200 based on the output torque command (Tq_final), and accordingly, the motor 100 is driven. For example, the torque command (Tq_final) can be converted into the form of a current command by being input to the current map, and the controller 300 can generate a voltage command through feedback control based on the current command, and control the switching of the inverter 200 through a PWM signal based on the voltage command, thereby ultimately controlling the driving of the motor 100.

Meanwhile, the final torque command determination unit 350 may additionally obtain the accelerator pedal position (APS) from the sensor unit 10 and selectively apply the second torque value (Tq2) to the torque command (Tq_final) reflecting the accelerator pedal position (APS).

For example, the final torque command determination unit 350 may be configured to determine the second torque value (Tq2) as the torque command (Tq_final) if the detected accelerator pedal position (APS) exceeds a predetermined value, and may be configured to determine a predetermined third torque value as the torque command (Tq_final) if the accelerator pedal position (APS) is less than or equal to the predetermined value. The predetermined value for the accelerator pedal position (APS) may be, for example, '0', but is not limited to this and may be preset to be variable according to the first torque value (Tq1).

Also, the controller 300 may be disposed with a logic monitoring function. For example, the controller 300 can check whether the torque inverse-calculation unit 310, torque compensation unit 320, first torque value determination unit 330, comparison unit 340, and final torque command determination unit 350 operate in a predetermined order, or whether the input and output values of the torque inverse-calculation unit 310, torque compensation unit 320, first torque value determination unit 330, comparison unit 340, and final torque command determination unit 350 are included within predetermined ranges.

For example, the controller 300 may be configured to determine that there is an error in the control logic if the operation sequence changes, such as the comparison unit 340 operating before the operation of the torque inverse-calculation unit 310, instead of the torque inverse-calculation unit 310, torque compensation unit 320, first torque value determination unit 330, comparison unit 340, and final torque command determination unit 350 operating in the listed order, or if input values like the inverse-calculated torque value (Tq_inverse) or output values like the first torque value (Tq1) are not included within the predetermined ranges.

If there is an error in the control logic as described above, the controller 300 may perform fail-safe operation, stop operation, reboot, etc. Here, the fail-safe operation may include, for example, determining the torque command (Tq_final) as the third torque value instead of the second torque value (Tq2).

Hereinafter, the control method of the electrified vehicle according to an exemplary embodiment will be explained with reference to the flowchart.

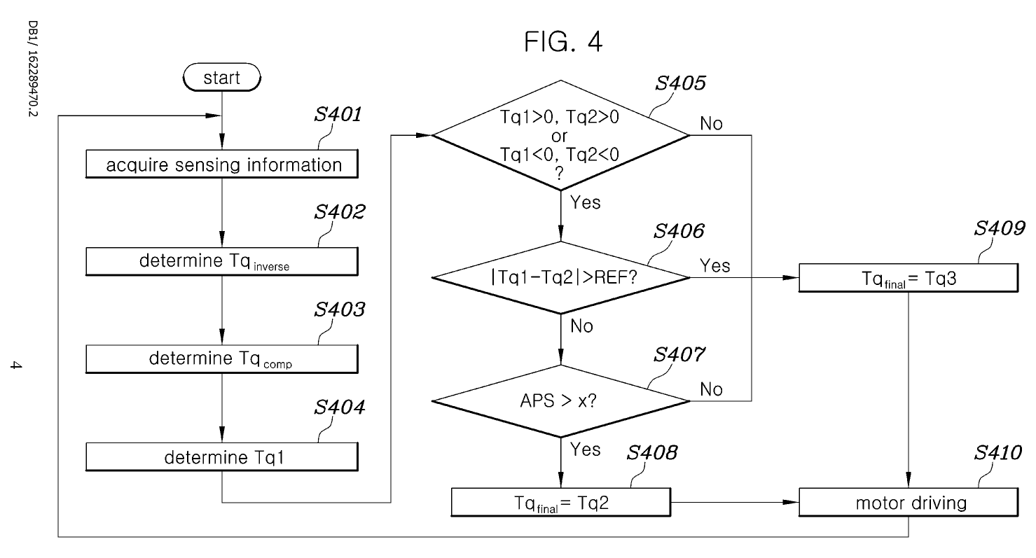

FIG. 4 is a flowchart explaining the control method of an electrified vehicle according to an exemplary embodiment of the present disclosure.

Referring to FIG. 4, the controller 300 first obtains sensing information such as the PWM signal, rotor position of the motor 100, phase current, DC voltage, temperature of the motor 100, accelerator pedal position, etc. through the sensor unit 10 in step S401.

The controller 300 is configured to determine the inverse-calculated torque value (Tq_inverse) based on the sensing information about the motor 100 and the inverter 200 among the obtained sensing information in step S402, and is configured to determine the compensation torque value (Tq_comp) based on the temperature of the motor 100 in step S403. In the instant case, the determination of the inverse-calculated torque value (Tq_inverse) in step S402 does not necessarily have to be performed before the determination of the compensation torque value (Tq_comp), and the order between the two may vary depending on the implementation.

Subsequently, the controller 300 is configured to determine the first torque value (Tq1) based on the inverse-calculated torque value (Tq_inverse) and the compensation torque value (Tq_comp) in step S404, and is configured to determine whether the second torque value (Tq2) corresponding to the current target torque satisfies a predetermined condition based on the determined first torque value (Tq1) in steps S405 and S406.

The predetermined condition may be satisfied, for example, when the first torque value (Tq1) and the second torque value (Tq2) have the same sign (Yes in step S405), and the difference between the first torque value (Tq1) and the second torque value (Tq2) does not exceed a predetermined reference value (REF) (No in step S406).

Additionally, the accelerator pedal position (APS) included in the sensing information may be further considered in the predetermined condition. For example, whether the accelerator pedal position (APS) exceeds a predetermined value (x) may be included in the predetermined condition.

If all the predetermined conditions are satisfied (Yes in step S407), the controller 300 may be configured to determine the second torque value (Tq2) corresponding to the target torque as the torque command (Tq_final) in step S408. If any one of the predetermined conditions is not satisfied (No in step S405, Yes in step S406, No in step S407), the controller 300 may be configured to determine a predetermined third torque value (Tq3) instead of the second torque value (Tq2) as the torque command (Tq_final) in step S409.

Once the torque command (Tq_final) is determined accordingly, the controller 300 is configured to control the inverter 200 based on the torque command (Tq_final), and accordingly, the motor 100 is driven in step S410.

According to various embodiments of the present disclosure as described above, the accuracy of torque control through the motor and inverter can be improved.

Additionally, since the normality of the torque command can be diagnosed at the motor controller level itself without using an upper-level controller, the diagnosis of the torque command and the response according to the diagnosis result can be performed promptly.

Although the predetermined embodiments of the present disclosure have been shown and described above, it will be apparent to those skilled in the art that various modifications, additions and substitutions are possible, without departing from the scope and spirit of the present disclosure as disclosed in the accompanying claims.

What is claimed is:

1. An electrified vehicle, comprising:
a motor;
an inverter connected to the motor and driving the motor; and
a controller operatively connected to the inverter and controlling the inverter based on a torque command,
wherein the controller selectively applies a second torque value corresponding to a current target torque to the torque command based on a first torque value determined based on sensing information of the motor and the inverter.

2. The electrified vehicle of claim 1, wherein the sensing information comprises at least one of a pulse width modulation (PWM) signal applied to the inverter, a rotor position of the motor, a phase current flowing through the motor, and a DC voltage applied to the inverter.

3. The electrified vehicle of claim 2, wherein the controller:
determines d-q axis current based on the sensing information; and
determines the first torque value based on an inverse-calculated torque value corresponding to the d-q axis current.

4. The electrified vehicle of claim 3, wherein the controller determines the inverse-calculated torque value with reference to a torque inverse-calculation map preset to output the inverse-calculated torque value corresponding to inputting the d-q axis current.

5. The electrified vehicle of claim 3,
wherein the sensing information further comprises a temperature of the motor, and
wherein the controller determines, as the first torque value, a torque value compensated based on the temperature of the motor for the inverse-calculated torque value corresponding to the d-q axis current.

6. The electrified vehicle of claim 1, wherein the controller applies the second torque value to the torque command based on the second torque value satisfying a predetermined condition, wherein satisfaction of the predetermined condition is determined based on the first torque value.

7. The electrified vehicle of claim 6, wherein the controller determines that the predetermined condition is satisfied based on the second torque value having the same sign as the first torque value.

8. The electrified vehicle of claim 6, wherein the controller determines that the predetermined condition is satisfied based on the second torque value having a difference from the first torque value less than or equal to a predetermined reference value.

9. The electrified vehicle of claim 6, wherein the controller applies a predetermined third torque value to the torque command based on the second torque value not satisfying the predetermined condition.

10. The electrified vehicle of claim 1, wherein the controller :
receives an accelerator pedal position of the vehicle; and
selectively applies the second torque value to the torque command further considering the accelerator pedal position.

11. The electrified vehicle of claim 1, wherein the controller comprises:
a torque inverse-calculation unit determining an inverse-calculated torque value corresponding to the sensing information;
a torque compensation unit determining a compensation torque value based on a temperature of the motor included in the sensing information;
a first torque value determination unit determining the first torque value based on the inverse-calculated torque value and the compensation torque value;
a comparison unit outputting a comparison result between a difference of the first torque value and the second torque value and a predetermined reference value; and
a final torque command determination unit selectively applying the second torque value to the torque command based on the comparison result;
wherein the final torque command determination unit selectively applies the second torque value to the torque command further considering whether the torque inverse-calculation unit, the torque compensation unit, the first torque value determination unit, and the comparison unit operate in a predetermined order.

12. The electrified vehicle of claim 1, wherein the controller comprises:
a torque inverse-calculation unit determining an inverse-calculated torque value corresponding to the sensing information;
a torque compensation unit determining a compensation torque value based on a temperature of the motor included in the sensing information;
a first torque value determination unit determining the first torque value based on the inverse-calculated torque value and the compensation torque value;
a comparison unit outputting a comparison result between a difference of the first torque value and the second torque value and a predetermined reference value; and
a final torque command determination unit selectively applying the second torque value to the torque command based on the comparison result;
wherein the final torque command determination unit selectively applies the second torque value to the torque command further considering whether input values and output values of the torque inverse-calculation unit, the torque compensation unit, the first torque value determination unit, and the comparison unit are included within respective predetermined ranges.

13. A control method of an electrified vehicle including a motor and an inverter connected to the motor and configured to drive the motor, the method comprising:
selectively applying, by a processor, a second torque value corresponding to a current target torque to a torque command based on a first torque value determined based on sensing information of the motor and the inverter; and
controlling, by the processor, the inverter based on the torque command.

14. The control method of claim 13, wherein the sensing information comprises at least one of a pulse width modulation (PWM) signal applied to the inverter, a rotor position of the motor, a phase current flowing through the motor, and a DC voltage applied to the inverter.

15. The control method of claim 14, wherein the selectively applying comprises:
determining, by the processor, d-q axis current based on the sensing information; and
determining, by the processor, the first torque value based on an inverse-calculated torque value corresponding to the d-q axis current.

16. The control method of claim 15,
wherein the sensing information further comprises a temperature of the motor, and
wherein the selectively applying comprises determining, as the first torque value, a torque value compensated based on the temperature of the motor for the inverse-calculated torque value corresponding to the d-q axis current.

17. The control method of claim 13, wherein the selectively applying comprises:
applying, by the processor, the second torque value to the torque command based on the second torque value satisfying a predetermined condition, wherein satisfaction of the predetermined condition is determined based on the first torque value; and
applying, by the processor, a predetermined third torque value to the torque command based on the second torque value not satisfying the predetermined condition.

18. The control method of claim 17, wherein the selectively applying comprises:
determining, by the processor, that the predetermined condition is satisfied based on at least one of the second torque value having the same sign as the first torque value, or the second torque value having a difference from the first torque value less than or equal to a predetermined reference value.

19. The control method of claim 13, further comprising:
receiving, by the processor, an accelerator pedal position of the vehicle;
wherein the selectively applying comprises selectively applying, by the processor, the second torque value to the torque command further considering the accelerator pedal position.

20. The control method of claim 13, further comprising:
determining, by the processor, an inverse-calculated torque value corresponding to the sensing information;
determining, by the processor, a compensation torque value based on a temperature of the motor included in the sensing information;
determining, by the processor, the first torque value based on the inverse-calculated torque value and the compensation torque value; and
outputting, by the processor, a comparison result between a difference of the first torque value and the second torque value and a predetermined reference value;
wherein the selectively applying comprises selectively applying the second torque value to the torque command further based on at least one of whether the determining of the inverse-calculated torque value, the determining of the compensation torque value, the determining of the first torque value, and the outputting of the comparison result operate in a predetermined order, or whether the sensing information, the inverse-calculated torque value, the compensation torque value, the first torque value, the second torque value, and the comparison result are each included within a respective predetermined range.
